(19) United States
(12) Patent Application Publication
(10) Pub. No.: US 2007/0152140 A1
(43) Pub. Date: Jul. 5, 2007

(54) Sensing system and method

(75) Inventors: Chin-Kuei Lee, Kaohsiung City (TW); Meng-Shin Yen, Taipei City (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/645,653

(22) Filed: Dec. 27, 2006

(30) Foreign Application Priority Data
Dec. 29, 2005 (TW) 94147219

(51) Int. Cl. G06M 7/00; H01J 40/14

(52) U.S. Cl. 250/221

(57) ABSTRACT

A sensing system for detecting movement of an object is disclosed, including a laser source having a cavity emitting laser beams, a reflecting film, one side acting as a reflecting surface for the laser beams and the other side allowing the object to move thereover, with a plurality of pores having a distribution of a particular regulatory in area and/or density, an optical path focusing the laser beams onto the reflecting film, a measuring/converting module detecting variation in laser operation in the cavity induced by the laser beams reflected from the reflecting film and generating a corresponding electrical signal, and an analyzing circuit receiving and analyzing the electrical signal to determine the movement of the object.

### BACKGROUND OF THE INVENTION

1. Field of the Invention

The invention relates to sensing systems, and in particular to a sensing system utilizing laser self-mixing effect.

2. Description of the Related Art

Input devices in conventional electronic devices acquire user information via mechanical means, such as mechanical mouse, mechanical keyboard and mechanical stick. Users activate a mechanical component (for example, a button of or ball of a mouse) such that the mechanical component activates a contact sensor, which generates a signal. Mechanical components tend to be covered and accumulate dust but are difficult to clean. Also, the press signal is one-by-one enabled.

Conventional optical guiding technologies, unlike mechanical technologies, emit light to an object such as a desktop, a finger, and a virtual trace ball as disclosed in TW patent M256537, and determine movement of the object by sensing the displacement of reflected light from the object via a sensor. As disclosed in European Patent No. EP-0942282, laser beams are emitted to an object and diffracted partially by a raster. Diffracted laser beams are reflected into a sensor. The sensor then determines the movement of the object by interleaving the reflected laser beams. However, components of optical guiding devices require calibration and matching, increasing production complexity and costs.

In view of these problems, U.S. Pat. No. 6,707,027 discloses a sensing system applied in input devices of electronic systems and applying laser self-mixing effect. FIG. 1 is a cross-section of a sensing system 100 disclosed in the patent comprising a base plate 1 to carry a diode laser 3 and a sensor (such as a photo diode) 4. The diode laser 3 emits laser beams 13. An object 15 such as a finger to be detected moves on a transparent window 12. A lens 10 is arranged between the diode laser 3 and the transparent window 12, focusing the laser beams 13 on or near the transparent window 12. The laser beams 13 are reflected by the object 15, and some of the reflected laser beams are converged by the lens 10 to re-enter the cavity of the diode laser 3. The radiation returning in the cavity interferes with radiation therein, referred to as self-mixing effect, further inducing variation in intensity of the laser radiation emitted by the diode laser 3. The photo diode 4 receives and converts part of the laser radiation in the cavity to an electrical signal. A circuit 18 analyzes the movement of the object 15 according to the electrical signal.

FIG. 2 shows waveforms of a driving current of the diode laser 3 and intensity of the laser radiation in the cavity, illustrating principle of the circuit analyzing the moving direction and speed of the object 15 according to the electrical signal. As shown, the laser diode 3 is driven by a triangular AC driving circuit. Due to Doppler and Laser self-mixing effects, when the object 15 moves towards and away from the object 3, ripple component of the intensity of the laser radiation in the cavity exhibits waveforms 21 and 22 respectively. The circuit 18 determines the moving direction of the object by subtracting wave number in interval ½p(a) from that in interval ½p(2). Additionally, the difference between the wave numbers in intervals ½p(a) and ½p(b) increases with the speed of the object 15. The circuit 18 thus determines the speed of the object 15 according to the difference between the wave numbers in intervals ½p(a) and ½p(b).

Sensing system 100 in FIG. 1 includes a diode laser 3 and a sensor 4 for one-dimensional movement detection of the object 15. To achieve two or three dimensional movement detection of an object, two or three diode lasers and sensors are disposed in the sensing system. Additionally, if a DC current is used to drive the diode laser, the moving direction of the object cannot be determined.

### BRIEF SUMMARY OF THE INVENTION

The invention provides a sensing system comprising a reflecting film with a plurality of pores having predetermined distribution. The sensing system, with a single diode laser, is capable of determining one to two dimensional movement of an object. The invention further provides a sensing system with a flexible film, capable of determining two or three dimensional movement of an object. Additionally, the diode laser in the electronic system can be driven by not only AC driving current such as triangular wave but also DC driving current, thereby reducing complexity of driving current circuit and analyzing circuit.

The invention provides a sensing system detecting movement of an object, comprising a laser source, a reflecting film, an optical path, a measuring/converting module, and an analyzing circuit. The laser source has a cavity emitting laser beams. The reflecting film, one side acting as a reflecting surface for the laser beams and the other side allowing the object to move thereover, comprises a plurality of pores with a predetermined distribution. The optical path focuses the laser beams onto the reflecting film. The measuring/converting module detects the variation in laser operation in the cavity and generates a corresponding electrical signal. The analyzing circuit receives and analyzes the electrical signal to determine the movement of the object.

In an embodiment of the sensing system, the porosity of the reflecting film, defined as the total pore area per unit area of reflecting film, decreases in a predetermined direction. In another embodiment of the sensing system, the porosity of the reflecting film decreases along first and second directions at different rates.

An embodiment of the analyzing steps performed by the analyzing circuit comprises detecting the amplitude variation of the ripple component of the electrical signal to determine the moving direction of the object. In another embodiment, the analyzing circuit analyzes the frequency of the ripple component of the electrical signal to determine the speed of the object. In another embodiment, the reflecting film is flexible, and the analyzing circuit detects whether the amplitude variation in the ripple component of the electrical signal is less than a predetermined amplitude to determine whether the object presses the reflecting film.

The invention also provides an electronic system comprising an input device including the sensing system.

### BRIEF DESCRIPTION OF THE DRAWINGS

The invention can be more fully understood by reading the subsequent detailed description and examples with references made to the accompanying drawings, wherein:

FIG. 1 is a cross-section of a sensing system disclosed in U.S. Pat. No. 6,707,027;

FIG. 2 shows waveforms of a driving current of a diode laser and intensity of laser radiation in a cavity of FIG. 1;

FIG. 3 is a block diagram of a sensing system in accordance with an embodiment of the invention;

FIGS. 4A, 4C and 4B, 4D respectively show intensity of the laser radiation emitted from a cavity when an object stays stationary and moves with a constant velocity over first and second region of a reflecting film of FIG. 1, where a laser source is driven by DC and triangular driving currents respectively in FIGS. 4A-4B and 4C-4D;

FIGS. 5A-5C are plan views of pore distributions of a reflecting film in accordance with embodiments of the invention;

FIGS. 6A and 6B show intensities of laser radiation emitted from a cavity when an object moves at different constant velocities over the same region of a reflecting film respectively when a laser source a is driven by DC and AC driving currents;

FIGS. 7A and 7B respectively show cross sections of a reflecting film when deforming and recovering in accordance with an embodiment of the invention;

FIGS. 8A and 8B show intensity of laser radiation emitted from a cavity in the embodiment of FIGS. 7A and 7B respectively when a laser source is driven by DC and AC driving currents; and

FIGS. 9A and 9B show application of the invention using a portable computer having a sensing system of the invention as an example;

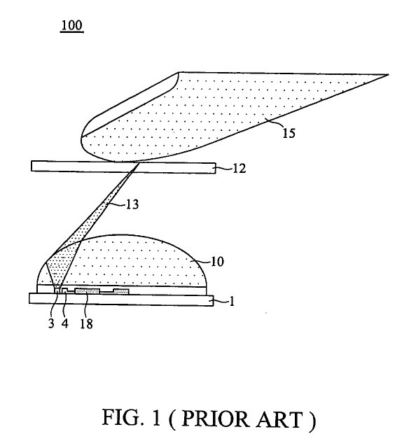

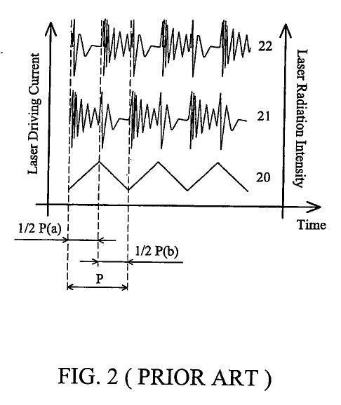

### DETAILED DESCRIPTION OF THE INVENTION

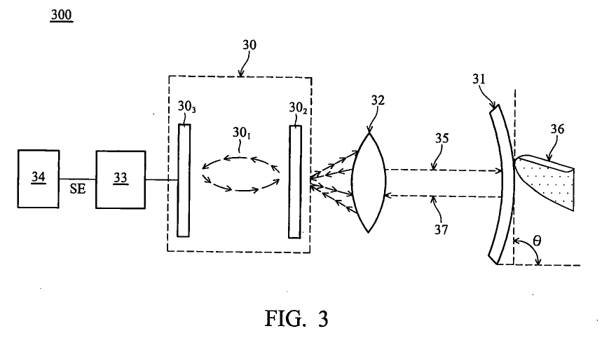

FIG. 3 is a block diagram of a sensing system 300 in accordance with an embodiment of the invention. The sensing system 300 comprises a laser source 30, a reflecting film 31, a optical path 32, a measuring/converting module 33, and an analyzing circuit 34. As shown, the laser source 30, a diode laser, comprises a cavity 30₁, a front facet 30₂ and a rear facet 30₃. The laser source 30 emits laser beam 35 through the front laser facet 30₂. The optical path 32, such as a convex lens, disposed between the laser source 30 and the reflecting film 31, collimates and focuses the laser beam 35 on or near the reflecting film 31. The laser beam 35 becomes substantially parallel after passing through the optical path 32.

The reflecting film 31 has a plurality of circular, square, elliptical or linear pores with a predetermined distribution of area and/or density. One side of the reflecting film 31 acts as a reflecting surface for the laser beam 35 to reflect part of the laser beam 35, and the other side allows an object 36 (for example, a finger) to move thereover. It is noted that the object 36 is not required to closely contact the reflecting film 31 and is only required to move near thereto. Reflected part of the laser beam 35 is denoted by reference number 35 in the figure. Since the areas and/or densities of the pores on the reflecting film 31 are distributed regularly, when the object 36 moves over the reflecting film 31, reflected beam 37 corresponding to the pore distribution is generated.

Preferably, reflection coefficient of the reflecting film 31 is much less than that of the object 36, such as a rough black surface with no tendency to reflect light. In this case, the laser beam 35 is reflected when reaching the object 36 and absorbed when reaching the surface of the reflecting film 31. As such, when the object 36 moves in a region of higher porosity, the intensity of the reflected beam 37 is higher. In another preferable embodiment, reflection coefficient of the reflecting film 31 exceeds substantially that of the object 36, such as a smooth surface with a high tendency to reflect light. In this case, the laser beam 35 is absorbed when reaching the object 36 and reflected when reaching the surface of the reflecting film 31. As such, when the object 36 moves in a region of higher porosity, the intensity of the reflected beam 37 is lower. In these two embodiments, when the object moves over the surface of the reflecting film 31, the intensity of the reflected beam 37 varies according to the distribution of the pores. While the following paragraphs references reflection coefficient of the reflecting film 31 being much less than that of the object 36, those skilled in the art should be readily able to deduce the case where reflection coefficient of the reflecting film 31 exceeds substantially than that of the object 36.

The reflection beam 37 is further collimated and focused on the light source 30 by the optical path and reenters the cavity 30₁, interfering with optical rays within the cavity 30, and modulating the amplitude and frequency of rays emitted from the cavity 30₁, creating a self-mixing effect. Since movement of the object 36 over the reflecting film 31 results in the reflected beam 37 corresponding to the pore distribution, when the reflection beam 37 enters the cavity 30₁ and interferes with the optical rays therein, variation of the optical radiation from the cavity 30₁ also corresponds to the cavity 30₁.

The measuring/converting module 33 detects variation in laser operation induced by the self-mixing effect within the cavity 30₁ and generates an electrical signal SE correspondingly. In an embodiment, the measuring/converting module 33 includes a photo diode. The photo diode absorbs part of the laser radiation from the cavity 30₁, and converts the intensity of the laser radiation to the electrical signal SE. In another embodiment, the measuring/converting module 33 includes an impedance measuring device coupled to the cavity 30₁ to measure the impedance of the cavity 30₁. Since the impedance of the cavity 30₁ is reversely proportional to the intensity of the laser radiation within the cavity 30₁, the measured impedance can be converted to the electrical signal SE representing the intensity of the laser radiation.

The measuring/converting module 33 then transmits the electrical signal SE to the analyzing circuit 34. The analyzing circuit 34 sequentially makes an analysis of the electrical signal SE to detect movement of the object 36. The analyzing circuit 34 is able to detect the movement of the object 36 via analysis of the variation in the electrical signal SE when the object 36 moves over the reflecting film 31 by variations in porosity.

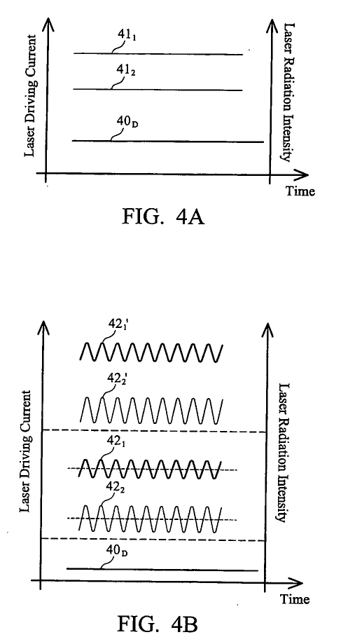

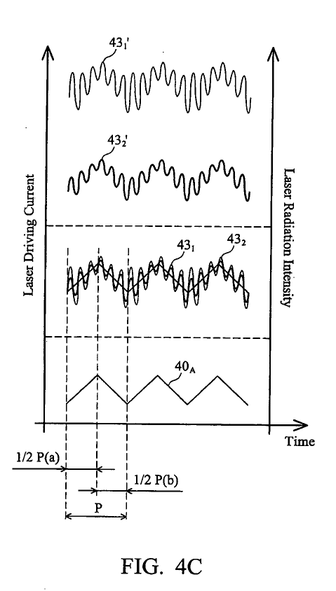

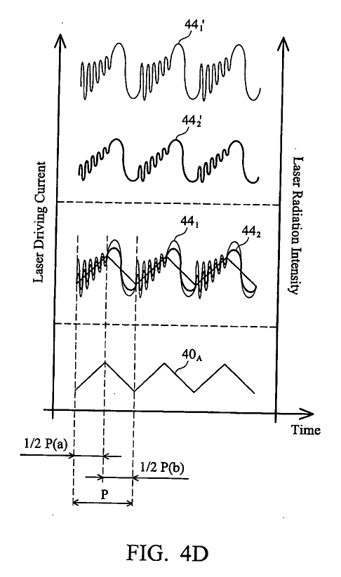

FIGS. 4A-4D, 7A-7B and 9A-9B show intensities of the laser radiation emitted from the cavity 30, of sensing system 300 with different motions of the object 36, illustrating principle of the analyzing circuit 34 analyzing the electrical signal to detect the movement of the object 36.

In the following, the reflecting film 31 has different porosities, the amplitude of the intensity of the laser radiation within the cavity varies with the position of the object.

FIGS. 4A and 4B respectively show intensity of the laser radiation emitted from the cavity 30₁ when the object 36 stays stationary and moves with a constant velocity over first and second regions (with lower porosity than the first region) of the reflecting film 31, where the laser source 30 is driven by a DC driving current. Referring to FIG. 4A, the DC driving current is denoted by reference number 40_{D}, and the intensities of the laser radiation are represented by reference numbers 40₁ and 40₂ respectively when the object stays stationary in the first and second region. Since the first region has a higher porosity than the second region, reflected beam 37 has higher intensity when the object is located in the first region than in the second region, and accordingly, amplitude of the intensity of the laser radiation 41₁ exceeds that of the intensity of the laser radiation 41₂. Referring to FIG. 4b, when the object moves with a constant velocity in the first and second regions, the intensity of the laser radiation are respectively represented by reference numbers 42₁ and 42₂, and the intensities of the ripple component of the laser radiation are respectively represented by reference numbers 42′₁ and 42′₂ (difference in the heights relative to the transverse axis is for only illustration, not representing the difference of the amplitudes). Similarly, amplitude of the ripple component of the intensity of the laser radiation 42′₁ exceeds that of the ripple component of the intensity of the laser radiation 42′₂.

FIGS. 4C and 4D respectively show intensity of the laser radiation emitted from the cavity 30₁ when object 36 stays stationary and moves with a constant velocity (towards the cavity 30₁) over first and second regions (with lower porosity than the first region) of the reflecting film 31, where the laser source 30 is driven by a triangular AC driving current. In FIG. 4C, the triangular AC driving current is denoted by reference number 40_{A}, and when the object stays stationary in the first and second regions, the intensity of the laser radiation is respectively represented by reference numbers 43₁ and 43₂, and the intensities of the ripple of the laser radiation are respectively represented by reference numbers 43′₁ and 43′₂ (difference in the heights relative to the transverse axis is for only illustration, no representing the difference of the amplitudes). Since the first region has a higher porosity than the second region, reflected beam 37 has higher intensity when the object is located in the first region than in the second region, and accordingly, amplitude of the intensity of the laser radiation 41₁ exceeds that of the intensity of the laser radiation 41₂. Referring to FIG. 4D, when the object moves with a constant velocity in the first and second regions, the intensities of the laser radiation are respectively represented by reference numbers 44₁ and 44₂, and the intensities of the ripple of the laser radiation are respectively represented by reference numbers 44′₁ and 44′₂. Similarly, amplitude of the ripple component of the laser radiation 43′₁ exceeds that of the intensity of the ripple component of the laser radiation 43′₂, and amplitude of the ripple component of the intensity of the laser radiation 44′₁ exceeds that of the ripple component of the intensity of the laser radiation 44′₂.

It is noted that FIG. 4D illustrates the case in which the object 36 moves towards the cavity 30₁. In such a case, the frequency of the intensity of the laser radiation in rising period ½p(a) of the triangular AC driving current exceeds that in falling period ½p(b) of the triangular AC driving current. However, when the object 36 moves away from the cavity 301, amplitude of the ripple component of the intensity of the laser radiation increases (decreases) with the increase (decrease) in the porosity of the region where the object is located, with the only difference being the frequency of the intensity of the laser radiation in rising period ½p(a) of the triangular AC driving current is less than that in falling period ½p(b) of the triangular AC driving current.

As shown in FIGS. 4A-4D, amplitude of the ripple component of the intensity of the laser radiation depends upon the porosity of the region where the object 36 is located. Accordingly, in an embodiment of the invention, the reflection film 31 has different porosity in different regions, and after the measuring/converting module 33 generates and passes a corresponding electrical signal SE to the analyzing circuit 34, the analyzing circuit 34 determines the position of the object 36 by detecting the amplitude of the electrical signal SE. In another embodiment, the analyzing circuit 34 determines the moving direction of the object by detecting the variation in the amplitude of the ripple component of the electrical signal. When the amplitude of the ripple component of the electrical signal decreases, the object 36 moves from a region with higher porosity to another region with a lower porosity.

It is noted that, when the laser source 30 is driven by a triangular AC current, the measuring/converting module generates a triangular electrical signal. For this reason, the analyzing circuits may include a filtering circuit to differentiate the triangular electrical signal into a square electrical signal in order to obtain the ripple component of the electrical signal for latter analysis. Further, in addition to the prementioned DC and triangular AC driving currents, driving currents of other shapes, such as square AC current, may also be applied to drive the laser source 30.

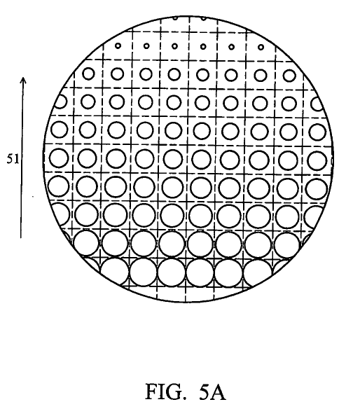

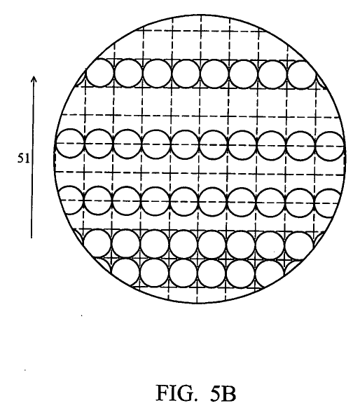

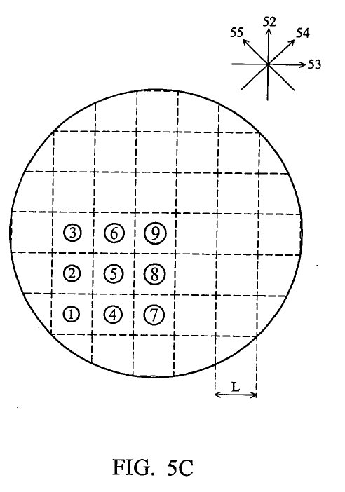

In an embodiment, the porosity of the reflecting film 31 is decreased along a predetermined direction for detection of one-dimensional movement of the object 36. FIGS. 5A and 5B are plan views of distributions of pores of the reflecting film 31 in the embodiment. In FIG. 5A, the spacing of the pores of the reflecting film 31 is constant while area of each pore decreases along a predetermined direction 51. In FIG. 5B, the spacing of the pores of the reflecting film is decreased along the predetermined direction 51 while area of each pore is constant. In both of the embodiments, the porosities of the reflecting film 31 are decreased along the predetermined direction 51. It is noted that in addition to the distribution illustrated in FIGS. 5A and 5B, spacing and area of each pore may have other distributions resulting in a decreased porosity along a predetermined direction. In the two embodiments, the analyzing circuit 34 determines whether the object 36 moves forwards or backwards along the predetermined direction 51 by detecting whether the variation of the amplitude in the ripple component of the electrical signal SE is negative or positive in a predetermined period.

In another embodiment, the porosity of the reflecting film 31 is decreased along first and second predetermined directions with different decreasing rate for detection of two-dimensional movement of the object 36. FIG. 5C is a plan view of distribution of pores of the reflecting film 31 in the embodiment. As shown, the spacing of the pores of the reflecting film 31 is constant while area of each pore is decreased along first and second predetermined directions 52 and 53, where area differences between two neighboring pores are unequal along the two predetermined directions 52 and 53. For example, in FIG. 5C, the number for each pore denotes area of the pore (area of each pore drawn in the figure, however, is not procomponental to the real area of the pore for clear illustration). As shown, area differences between two neighboring pores are 1 and 3 respectively along the first and second predetermined directions 52 and 53. In the embodiment, the analyzing circuit 34 determines whether the object 36 moves along the first predetermined direction 52 (or along the opposite direction thereto), the second predetermined direction 53 (or along the opposite direction thereto), third predetermined direction 54 (or along the opposite direction thereto), or fourth predetermined direction 55 (or along the opposite direction thereof), by detecting whether the variation in the amplitude of the ripple component of the electrical signal SE is −/+1, −/+3, −/+4 or −/+2 in a predetermined period. If the intervals between the times when the analyzing circuit 34 detects the electrical signal SE is T, the speed of the object 36 is V, the time the object 36 moves between two neighboring pores L/V is required to equal several times T to obtain an accurate determination result. The accuracy of the determination result may thus be judged by calculation of the speed V of the object 36 and comparison of L/V and T.

Similarly, the two-dimensional moving direction of the object 36 can also be determined where area of each pore is constant while the spacing of the pores of the reflecting film 31 is decreased along first and second predetermined directions 52 and 53 with different decreasing rate.

In the embodiments for detection of the moving direction of the object 36, the shape of the reflecting film 31 can be flat, convex, or concave. The disposing angle θ can be set to 90° or other angles. Preferably, effects on the reflected beam 37 induced by the variation of incident angles of the laser beam 35 over the inflecting film 31 and distance between the cavity 30₁ and the reflecting film 31 are so much less than that induced by variation of porosity all over the reflecting film 31 to be ignored or filtered by a filtering circuit.

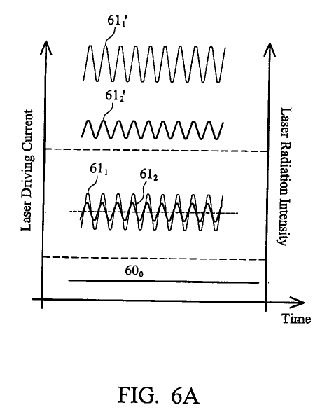

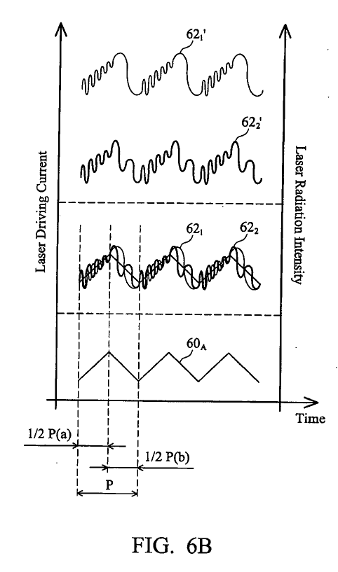

In the following, as shown in FIGS. 6A and 6B, shape or disposing angle of the reflecting film 31 are such that the incident angle of the laser beam 35 generated with the laser source 30 on the reflecting film is not 90°, the reflected beam 37 undergoes “Doppler effect” when the object 36 moves over the reflecting film 31, causing frequency of the ripple component of the laser radiation within the cavity 301 to vary with the speed of the object 36.

FIG. 6A shows intensity of the laser radiation emitted from the cavity 30₁ when the object 36 moves at constant velocities V1 and V2 (|V1|>|V2|) over the same region of the reflecting film 31, where the laser source 30 is driven by a DC driving current. In the figure, the DC driving current is denoted by reference number 60D, and the intensity of the laser radiation is respectively represented by reference numbers 61₁ and 61₂, and the intensities of the ripple of the laser radiation are respectively represented by reference numbers 61′₁ and 61′₂ respectively when the object 36 moves with velocities V1 and V2 (difference in the heights relative to the transverse axis is for only illustration, not representing the difference in amplitudes). As shown, frequency of the ripple component of the intensity of the laser radiation 61′₁ exceeds that of ripple component of the intensity of the laser radiation 61′₂.

Similarly, FIG. 6B shows intensity of the laser radiation emitted from the cavity 30₁ when object 36 moves at constant velocities V1 and V2 (|V1|>|V2|, and both towards the cavity 30₁) over the same region of the reflecting film 31, where the laser source 30 is driven by a triangular AC driving current. In the figure, the triangular AC driving current is denoted by reference number 60_{A}, and the intensity of the laser radiation are respectively represented by reference numbers 62₁ and 62₂, and the intensities of the ripple of the laser radiation are respectively represented by reference numbers 62′₁ and 62′₂ respectively when the object 36 moves with velocities V1 and V2 (difference in the heights relative to the transverse axis is for only illustration, not representing the difference in amplitudes). As shown, in rising period ½p(a) of the triangular AC driving current, the frequency of the ripple component of the intensity of the laser radiation 62′₁ exceeds that of the ripple component of the intensity of the laser radiation 62′₂; in falling period ½p(b) of the triangular AC driving current, frequency of the ripple component of the intensity of the laser radiation 62′₁ is less that that of the ripple component of the intensity of the laser radiation 62′₂.

It is noted FIG. 6B illustrates the case in which the object 36 moves towards the cavity 30₁. However, when the object 36 moves away from the cavity 301, the only difference is that the frequency of the intensity of the laser radiation in rising period ½p(a) of the triangular AC driving current is less than that in falling period ½p(b) of the triangular AC driving current. When the object 36 moves with velocities V1 and V2, in rising period ½p(a) of the triangular AC driving current, the frequency of the ripple component of the intensity of the laser radiation 62′₁ is less than that of the ripple component of the intensity of the laser radiation 62′₂; in falling period ½p(b) of the triangular AC driving current, frequency of the ripple component of the intensity of the laser radiation 62′₁ exceeds of the ripple component of the intensity of the laser radiation 62′₂.

As shown in FIGS. 6A and 6B, frequency of the ripple component of the intensity of the laser radiation varies with the speed of the object 36. Accordingly, after the measuring/converting module 33 generates and passes a corresponding electrical signal SE to the analyzing circuit 34, the analyzing circuit 34 determines the speed of the object 36 by detecting the frequency of the ripple component of the electrical signal SE. It is also noted that, when the laser source 30 is driven by a triangular AC current, the measuring/converting module generates a triangular electrical signal. For this reason, the analyzing circuits may include a filtering circuit to differentiate the triangular electrical signal into a square electrical signal to obtain the ripple component of the electrical signal for latter analysis. Further, in addition to the prementioned DC and triangular AC driving currents, driving currents of other shapes, such as square AC current, may also be applied to drive the laser source 30.

In an embodiment of the invention, the analyzing circuit 34 obtains the velocity of the object 36 according to the speed and moving direction thereof, and obtains the position of the object by integrating the speed with time.

In the embodiments for detection of the moving direction of the object 36, the shape of the reflecting film 31 can be flat, convex, or concave. The disposing angle θ can be set to 90° or other angles. Preferably, effects on the reflected beam 37 induced by the variation of incident angles of the laser beam 35 over the inflecting film 31 and distance between the cavity 30₁ and the reflecting film 31 are so much less than that induced by variation of porosity all over the reflecting film 31 to be ignored or filtered by a filtering circuit.

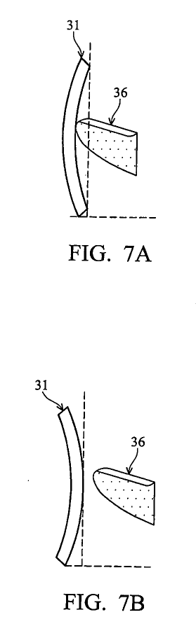

In another embodiment, the reflecting film is a flexible material so as to deform when being pressed by the object 36 and recover when the object 36 moves away, cross sections respectively shown in FIGS. 7A and 7B. The analyzing circuit 30 thus determines whether the object presses the reflecting film 31 by detecting the variation in the electrical signal SE induced by the deformation of the reflecting film 31.

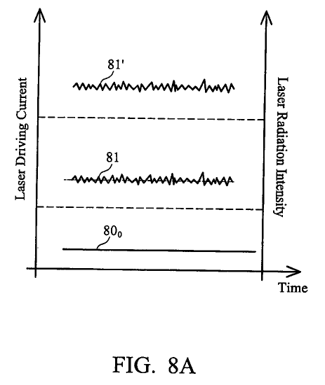

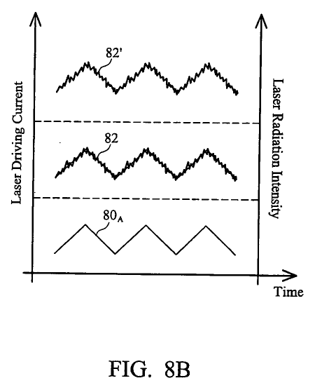

In the following, as shown in FIGS. 8A and 8B describes the ripple component of the laser radiation within the cavity 30₁ vanishes due to the deformation of the reflecting film 31 induced by the pressing with the object 36.

FIG. 8A shows intensity of the laser radiation emitted from the cavity 30₁ when the object 36 presses and thereby deforms the reflecting film 31, where the laser source 30 is driven by a DC driving current. In the figure, the DC driving current is denoted by reference number 80_{D}, and the intensity of the laser radiation is represented by reference number 81, and the intensity of the ripple of the laser radiation is represented by reference number 81′₁. As shown, amplitude of the ripple component 81′ vanishes almost completely, since the laser beam 35 cannot focus precisely on the reflecting film 31 when the reflecting film 31 is pressed and hollowed.

FIG. 8B shows intensity of the laser radiation emitted from the cavity 30₁ when the object 36 presses and thereby deforms the reflecting film 31, where the laser source 30 is driven by a triangular AC driving current. In the figure, the triangular AC driving current is denoted by reference number 80_{A}, and the intensity of the laser radiation is represented by reference number 82, and the intensity of the ripple of the laser radiation is represented by reference number 82′₁. Similarly, amplitude of the ripple component 82′ vanishes almost completely.

As illustrated in FIGS. 8A and 8B, since amplitude of the ripple component of the intensity of the laser radiation within the cavity 30₁ vanishes almost completely, after the measuring/converting module 33 generates and passes a corresponding electrical signal SE to the analyzing circuit 34, the analyzing circuit 34 determines whether the object 36 presses the reflecting film 36 by detecting whether the ripple component of the electrical signal SE falls below a predetermined amplitude. The analyzing circuit 34 may determine whether the object 36 presses the reflecting film 36 by detecting other variations in the electrical signal SE induced by the deformation of the reflecting film 31. It is also noted that, when the laser source 30 is driven by a triangular AC current, the measuring/converting module generates a triangular electrical signal. For this reason, the analyzing circuits may include a filtering circuit to differentiate the triangular electrical signal into a square electrical signal to obtain the ripple component of the electrical signal for latter analysis. Further, in addition to the mentioned DC and triangular AC driving currents, driving currents of other shapes, such as square AC current, may also be applied to drive the laser source 30.

The sensing system of the invention can be disposed in an electronic system comprising an input device having the sensing system of FIG. 3. Users of the electronic system can provide information by moving an object since movement of the object thus can be sensed by the sensing system in the input device. The electronic system, for example, can be a desktop or portable computer, mobile set or other device.

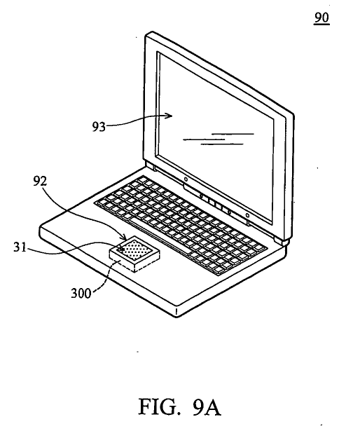

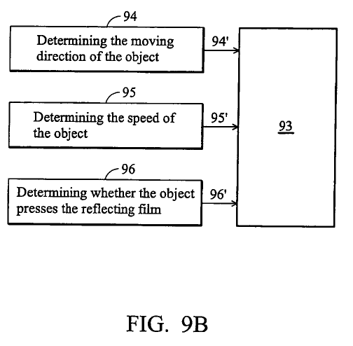

FIGS. 9A and 9B show applications of the invention by using a portable computer 90 with a sensing system of the invention as an example. The sensing system 300 of FIG. 3 acts as an input device of the portable computer 90, where the reflection film 31 is disposed in an input region 92. Users may move finger(s) over the reflection film 31 and a display region 93 generates display information accordingly. FIG. 9B is a logic block diagram of analyzing circuit 34 in the sensing system 300 in accordance with an embodiment of the invention. In Block 94, the moving direction of the finger(s) is determined via analysis of variation in amplitude of the electrical signal SE, and an output signal 94′ is generated to control the moving direction of a pointer shown on the display region 93. In Block 95, the speed of the finger(s) is determined via analysis of the frequency of the electrical signal SE, and an output signal 95′ is generated to control the speed of the pointer shown on the display region 93. The output signals 94 and 95 can control scrolling of the display region 93 in one dimension detection, and can control the position of the pointer shown on the display region 93. In block 96, whether the finger(s) presses the reflection film 31 is determined by detecting whether the amplitude of the electronic system disappears and an output signal 96′ is generated correspondingly to activate operation of “clicking”. It is noted that the analyzing circuit 34 is not required to include all of the blocks 94, 95, and 96. Different combinations of the blocks 94, 95, 96 are included in the analyzing circuit as required. For example, the analyzing circuit 34 includes only the blocks 94 and 95 to control the speed and moving direction of a pointer, but does not include the block 93 for recognizing clicking function. Alternatively, the analyzing circuit 34 includes only blocks 94 and 96 to control the moving direction of a pointer and recognize clicking function, but not block 95 to control the speed of the pointer.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A sensing system for detecting movement of an object, comprising:
a laser source having a cavity emitting laser beams;
a reflecting film, one side acting as a reflecting surface for the laser beams and the other side allowing the object to move thereover, with a plurality of pores having predetermined distribution;
an optical path focusing the laser beams onto the reflecting film;
a measuring/converting module detecting variation in laser operation in the cavity induced by the laser beams reflected from the reflecting film and generating a corresponding electrical signal; and
an analyzing circuit receiving and analyzing the electrical signal to determine the movement of the object.

2. The sensing system of claim 1, wherein the measuring/converting comprise a photo diode receiving and converting part of the laser radiation in the cavity to the electrical signal.

3. The sensing system of claim 1, wherein the pores are circular, square, elliptical, or linear.

4. The sensing system of claim 1, wherein the porosity of the reflecting film decreases along a predetermined direction.

5. The sensing system of claim 1, wherein the pores have constant spacing and area decreasing along a predetermined direction.

6. The sensing system of claim 4, wherein the pores have spacing decreasing along a predetermined direction and constant spacing.

7. The sensing system of claim 6, wherein the analyzing system determines the movement of the object by detecting the variation in the electronic system induced by the distribution of the pores when the object moves on the reflecting film.

8. The sensing system of claim 1, wherein the analyzing circuit determines the position of the object by detecting the amplitude of the DC component of the electrical signal.

9. The sensing system of claim 1, wherein the analyzing circuit determines the moving direction of the object by detecting the amplitude variation in the ripple component of the electrical signal.

10. The sensing system of claim 1, wherein the incident angle of the laser beams on the reflecting film is not 90°; and wherein the analyzing circuit determines the speed of the object by detecting the frequency of the ripple component of the electrical signal.

11. The sensing system of claim 1,
wherein the analyzing circuit determines the moving direction of the object by detecting the amplitude variation of the ripple component of the electrical signal;
wherein the incident angle of the laser beams on the reflecting film is not 90°;
wherein the analyzing circuit determines the speed of the object by detecting the frequency of the ripple component of the electrical signal; and
wherein the analyzing circuit obtains the velocity of the object according to the moving direction and speed of the object, and obtains the position of the object by integrating speed with time.

12. The sensing system of claim 7, wherein the reflecting film is a flexible material, deforming when pressed by the object; and wherein the analyzing circuit determines whether the object presses the reflecting film by detecting the variation in the electrical signal induced by the deformation of the reflecting film.

13. The sensing film of claim 12, wherein the analyzing circuit determines whether the object presses the reflecting film by detecting whether the amplitude of the ripple component of the electrical signal is below a predetermined amplitude.

14. The sensing film of claim 1, wherein the analyzing circuit comprises a filtering circuit generating the ripple component of the electronic system.

15. A sensing system for detecting movement of an object, comprising:
a laser source having a cavity emitting laser beams;
a reflecting film, one side acting as a reflecting surface for the laser beams and the other side allowing the object onto move thereover, with the porosity decreasing along a predetermined direction;
an optical path focusing the laser beams to the reflecting film;
a measuring/converting module detecting variation in laser operation in the cavity induced by the laser beams reflected from the reflecting film and generating a corresponding electrical signal; and
an analyzing circuit receiving and analyzing the electrical signal to determine the movement of the object,
wherein analysis comprises detecting the sign of the amplitude variation of the ripple component of the electrical signal to determine whether the object moves along the predetermined direction or an direction opposite thereto.

16. The sensing system of claim 15, wherein the incident angle of the laser beams on the reflecting film is not 90°; and wherein the analyzing circuit determines the speed of the object by detecting the frequency of the ripple component of the electrical signal.

17. The sensing system of claim 15, wherein the reflecting film is a flexible material, deforming when pressed by the object; and wherein the analyzing circuit determines whether the object presses the reflecting film by detecting the variation in the electrical signal induced by the deformation of the reflecting film.

18. The sensing system of claim 17, wherein the analyzing circuit determines whether the object presses the reflecting film by detecting whether the amplitude of the ripple component of the electrical signal is below a predetermined amplitude.

19. A sensing method for detecting movement of an object, comprising:
providing a reflecting film, one side allowing the object to move thereover, with a plurality of pores having predetermined distribution;
providing a laser source having a cavity emitting laser beams onto the other side of the reflecting film;
detecting variation in the laser operation in the cavity induced by the laser beams reflected from the reflecting film and generating a corresponding electrical signal; and
determining the movement of the object by analyzing the electrical signal.

20. The sensing method of claim 19, wherein detection of variation of the laser operation in the cavity induced by the laser beams reflected from the reflecting film and generating a corresponding electrical signal comprises providing a photo diode receiving and converting part of the laser radiation in the cavity to the electrical signal.

21. The sensing method of claim 19, wherein the pores are circular, square, elliptical, or linear.

22. The sensing method of claim 19, wherein the porosity of the reflecting film decreases along a predetermined direction.

23. The sensing method of claim 22, wherein the pores have constant spacing and area decreasing along a predetermined direction.

24. The sensing method of claim 22, wherein the pores have spacing decreasing along a predetermined direction and constant spacing.

25. The sensing method of claim 19, wherein determination of the movement of the object by analyzing the electrical signal comprises determining the movement of the object by detecting the variation of the electronic system induced by the distribution of the pores when the object moves on the reflection.

26. The sensing method of claim 19, wherein determination of the movement of the object by analyzing the electrical signal comprises determining the position of the object by detecting the amplitude of the DC component of the electrical signal.

27. The sensing method of claim 19, wherein determination of the movement of the object by analyzing the electrical signal comprises determining the moving direction of the object by detecting the amplitude variation of the ripple component of the electrical signal.

28. The sensing method of claim 1, wherein the incident angle of the laser beams on the reflecting film is not 90°; and wherein determination of the movement of the object by analyzing the electrical signal comprises determining the speed of the object by detecting the frequency of the ripple component of the electrical signal.

29. The sensing method of claim 19,
wherein the incident angle of the laser beams on the reflecting film is not 90°; and
wherein determination of the movement of the object by analyzing the electrical signal comprises:
determining the moving direction of the object by detecting the amplitude variation of the ripple component of the electrical signal;
determining the speed of the object by detecting the frequency of the ripple component of the electrical signal; and
obtaining the velocity of the object according to the moving direction and speed of the object, and obtaining the position of the object by integrating the speed with time.

30. The sensing method of claim 19, wherein the reflecting film is a flexible material, deforming when pressed with the object; and wherein determination of the movement of the object by analyzing the electrical signal comprises determining whether the object presses the reflecting film by detecting the variation in the electrical signal induced by the deformation of the reflecting film.

31. The sensing film of claim 30, wherein determination of the movement of the object by analyzing the electrical signal comprises determining whether the object presses the reflecting film by detecting whether the amplitude of the ripple component of the electrical signal is below a predetermined amplitude.

32. The sensing film of claim 1, wherein determination of the movement of the object by analyzing the electrical signal comprises filtering the electrical signal to generate the ripple component thereof.

33. An electronic system comprising an input device comprising a sensing system for detecting movement of an object, the sensing system comprising:
a laser source having a cavity emitting laser beams;
a reflecting film, one side acting as a reflecting surface for the laser beams and the other side allowing the object to move thereover, with a plurality of pores having predetermined distribution;
an optical path focusing the laser beams to the reflecting film;
a measuring/converting module detecting variation of the laser operation in the cavity induced by the laser beams reflected from the reflecting film and generating a corresponding electrical signal; and
an analyzing circuit receiving and analyzing the electrical signal to determine the movement of the object.

34. The electronic system of claim 33, wherein the analyzing system determines the movement of the object by detecting the variation in the electronic system induced by the distribution of the pores when the object moves on the reflection.

35. The electronic system of claim 33, wherein the analyzing circuit determines the position of the object by detecting the amplitude of the DC component of the electrical signal.

36. The electronic system of claim 33, wherein the analyzing circuit determines the moving direction of the object by detecting the amplitude variation of the ripple component of the electrical signal.

37. The electronic system of claim 33, wherein the incident angle of the laser beams on the reflecting film is not 90°; and wherein the analyzing circuit determines the speed of the object by detecting the frequency of the ripple component of the electrical signal.

38. The electronic system of claim 33, wherein the reflecting film is a flexible material, deforming when pressed with the object; and wherein the analyzing circuit determines whether the object presses the reflecting film by detecting the variation of the electrical signal induced by the deformation of the reflecting film.
